(19) United States
(12) Patent Application Publication
(10) Pub. No.: US 2012/0284711 A1
(43) Pub. Date: Nov. 8, 2012

(54) Method and Arrangement for Configuring a Resource for a Virtual Runtime Environment

(75) Inventors: Otto NIESSER, Allersberg (DE); Halil Caglar ÜNVER, Nurnberg (DE)

(73) Assignee: Siemens Aktiengesellschaft, Muenchen (DE)

(21) Appl. No.: 13/462,360

(22) Filed: May 2, 2012

(30) Foreign Application Priority Data
May 6, 2011 (EP) EP11165167

(51) Int. Cl. G06F 9/455

(52) U.S. Cl. 718/1

(57) ABSTRACT

A method and an arrangement for configuring a resource or a plurality of resources for use by a first virtual runtime environment of a hardware platform, wherein at least one management device for virtual runtime environments is provided on the hardware platform and a second virtual runtime environment with a configuration device is also provided, and wherein in a first step the resource is assigned to the second runtime environment by the management device, in a second step the resource is configured by the configuration device, and in a third step the configured resource is assigned to the first runtime environment such that the configuration occurs largely without influencing the operational sequence of the management device and other virtual runtime environments, and such that the management device also does not require any drivers nor any specific settings and procedures to configure the resource.

### BACKGROUND OF THE INVENTION

1. Field of the Invention

The invention relates to data processing in a virtual runtime environments and, more particularly, to a method and arrangement for configuring a resource.

2. Description of the Related Art

In many applications, virtual runtime environments are realized on computers, i.e., on personal computers, where a plurality of virtual runtime environments can regularly be operated in parallel on the same hardware platform. As a result of such virtualization, multiple and also different operation systems can be operated in parallel with one another, i.e., simultaneously.

In this case, virtualization affords the advantage that the individual virtual runtime environments are largely decoupled from one another. As a result, for example, problems (“crashes” or the like) in a first runtime environment ideally have no adverse effects on the processing of programs in other runtime environments.

Such an architecture is also utilized in industrial automation arrangements, a control job or the like regularly being realized by a real time operation system (“RTOS”) and an automation program running thereon. In addition, other operation systems, which are often also designated as “GPOS”, i.e., “General Purpose Operation Systems”, are often installed in further virtual runtime environments.

Generally, the virtual runtime environments are generated and monitored by a management device, where the management device assigns the resources of the hardware platform to the individual virtual runtime environments or accesses the resources for a portion of the resources as a representative of the virtual runtime environments. Such a management device is also often designated as “VMM”, i.e., “Virtual Machine Monitor”.

It can thus be stated that virtualization technology allows virtual and real resources of the hardware platform to be shared and a plurality of “guest operation systems” to be able to run in an isolated manner on a single hardware platform. As a result, a user can, for example, start, stop or restart such a guest operation system, without influencing other guest operation systems of the same hardware platform. During a reconfiguration of a guest operation system, i.e., restart or rebooting, the guest operation system must not influence the operational sequence of the other virtual runtime environments and the operation systems installed therein. Another task of the management device concerns the allocation of the resources of the hardware platform in a dynamic manner to the individual virtual runtime environments and the local operation systems installed therein. This means that, during the runtime of the individual guest operation systems, the resources can be alternately assigned to the individual runtime environments. For this purpose, with respect to the runtime, resources have to be added or removed (“Device Hot Plug”), guest operation systems have to be started (Launching) or removed, and faulty guest operation systems have to be restarted (“Recovering”, “Restart”).

Some resources are directly assigned to the virtual runtime environments. A large number of other resources are, rather, “virtualized” by the management device and represented with dedicated virtual HW resources to the virtual runtime environments. In this case, rebooting of a guest operation system or the reallocation of such a resource can be realized by simply restarting the virtual machine or virtual runtime environment, where the virtualized hardware allocated in this case is provided as if it had only just started. In contrast thereto, the situation turns out to be more difficult if a real hardware resource is assigned to a guest operation system. In such a case, starting, restarting, booting or recovery of the guest operation system is more difficult because, in such a case, real hardware resources have to be reconfigured, i.e., they have to be put into a start state, for example. The requisite reconfiguration of a resource is always associated with specific procedures and instructions requiring special measures, drivers, etc., depending on the type of resource (Device), the manufacture thereof and the specific technical embodiment thereof. Moreover, direct access to registers and possibly to the BIOS of the hardware platform may regularly be required in this case.

The dynamic allocation and the management of hardware resources in such a virtual environment therefore require extensive programming of the management device (Virtual Machine Monitor), where the programming often also has to be changed in the case of a change in hardware resources. On the other hand, this means that the configuration steps, which are often also time-consuming, have the effect that the management device is thereby often blocked, in which case it can happen that correspondingly less computation time can be assigned to the virtual runtime environments.

Moreover, during the configuration or reconfiguration of individual hardware resources, other enquiries sent from the virtual runtime environments to the management device often cannot be processed or cannot be processed without a delay. These concerns, in particular, the case in which one of the guest operation systems has to be restarted (Booting process), because a large number of the hardware resources assigned to the guest operation system have to be reconfigured in such a case. A further problem is that some of the known hardware resources cannot be put back into a start state in an isolated manner. This means that a “Reset” for such individual resources is not possible in an isolated fashion without likewise resetting other resources. However, a reset of all of the hardware resources, i.e., a “Reset” of the complete hardware platform, would lead to a loss of all virtual runtime environments and thus of all guest operation systems.

### SUMMARY OF THE INVENTION

It is therefore an object of the present invention to simplify the management of hardware resources of a hardware platform with virtual runtime environments.

This and other objects and advantages are achieved in accordance with the invention by providing an arrangement and method in which the configuration of resources is not performed by the management device, i.e., a “Virtual Machine Monitor”, for example, but rather by a separate configuration device, which, for its part, is arranged in a separate virtual runtime environment. For this purpose, in accordance with the invention, the resource to be configured is assigned to the virtual runtime environment with the configuration device for the time period in which the resource is configured, and, after completion of the configuration, is again assigned to that virtual runtime environment whose guest operation system requires access to said resource.

In accordance with the invention, a method for configuring a resource for use by a first virtual runtime environment of a hardware platform is provided, where a management device for virtual runtime environments is also provided. Here, a second virtual runtime environment with a configuration device is provided, where during a first step the resource is assigned to the second runtime environment by the management device, during a second step the resource is configured by the configuration device, and during a third step the configured resource is assigned to the first runtime environment. The configuration thus occurs largely without influencing the operational sequence of the management device and other virtual runtime environments, where the management device also does not require any drivers nor any specific settings and procedures to configure the resources.

It is also an object of the invention to provide an arrangement for configuring a resource for use by a first virtual runtime environment of a hardware platform, where at least one management device for virtual runtime environments is installed on the hardware platform. Here, at least one second virtual runtime environment with a configuration device is arranged on the hardware platform, where the management device is configured to assign the resource to be configured to the second virtual runtime environment, the configuration device is configured to configure the resource, and the management device is configured to assign the configured resource to the first virtual runtime environment after the configuration. The advantages that can be realized by the method in accordance with the invention can be brought about by such an arrangement.

In one advantageous embodiment, in the second step, instead of the real hardware unit or hardware resource, a hardware unit simulating the resource to be configured, i.e., a virtual hardware unit, is assigned to a driver entity of the resource for the duration of the configuration. This is advantageous particularly in the cases in which provision is made for the driver entity to access the real hardware unit only in restricted fashion, i.e., for example, some registers of the real hardware unit can be processed only in a read manner and not in a write manner. Another advantageous application exists when the corresponding real hardware unit cannot be separately reset, for example, because no separate reset line for the hardware unit can be accessed. A further advantage consists in the fact that the real hardware unit can continue to be used elsewhere during the duration of the configuration of the driver entity, without the operation thereof being impaired or ended. Advantageously, after the configuration of the driver entity by the virtualized hardware unit the operating state of the real hardware unit can be ascertained or read out, where the reconfigured driver unit is then put into an operating state corresponding to the operating state of the real hardware unit before the real hardware unit is assigned to the driver entity instead of the virtual hardware unit. This ensures a consistency between the logical state of the driver unit and the logical state of the real hardware unit.

In another advantageous embodiment, at least an additional third virtual runtime environment is provided alongside the first and the second runtime environments. In the cases in which a resource is intended to change from a third runtime environment to a second runtime environment—this is also referred to as “Resource Swapping”—, the assignment of the resource to the third runtime environment is firstly canceled by the management device before the first step of the method is performed. As a result, the resource can then be assigned to the second runtime environment.

Advantageously, the configuration comprises placing a hardware unit assigned to the resource or to the driver entity of the resource into a predefined state, where the driver entity is advantageously a start state (“Init State”, “Reset State”). This has the advantage that the guest operation system which is intended to operate next with the resource is confronted with a state corresponding to a restarted real machine. Particularly in the cases in which the hardware unit cannot be placed into the start state, alternatively the state of the driver entity can be adapted to that of the hardware unit.

In another advantageous embodiment, the management device is configured such that reset instructions of the virtual runtime environments or of the guest operation systems arranged therein are intercepted, where the reset instructions concern the resetting of resources and the hardware units thereof. This ensures that the configuration device can be included in the reconfiguration of the resources that is associated with a reset. In particular, this can also prevent a resource or hardware unit that is used by a plurality of virtual runtime environments from being reset from one of the virtual runtime environments, while it is still being used by another of the virtual runtime environments. In the case of an intercepted reset instruction, the management device can decide whether the addressed resource is actually directly reset, or else the instruction for resetting is forwarded to the configuration device, where the configuration device then decides whether and in what way the affected resource is reset or reconfigured.

Equally, messages requesting access to a resource from one of the virtual runtime environments can likewise be forwarded to the configuration device and processed there. For this purpose, there can be a communication channel between the management device and the configuration device, thereby enabling the configuration device to give the management device instructions about the cancelation and allocation of resources to the other virtual runtime environments.

Advantageously, instead of individual resources, lists or groups comprising a plurality of resources can also be formed and configured all together. As a result, time can be saved in comparison with individual configuration.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the method according to the invention are explained below with reference to the drawings. They simultaneously serve for elucidating exemplary embodiments of the arrangement according to the invention, in which:

FIG. 1 shows in schematic illustration possible operating states of a resource based on the example of an input or output device;

FIG. 2 shows in schematic illustration the assignment of driver entities as resources to virtual runtime environments when changing (“Swapping”) a resource from one virtual runtime environment to another virtual runtime environment; and

FIG. 3 is a flow chart of the method in accordance with an embodiment of the invention.

### DETAILED DESCRIPTION OF THE PREFERRED EMBODIMENTS

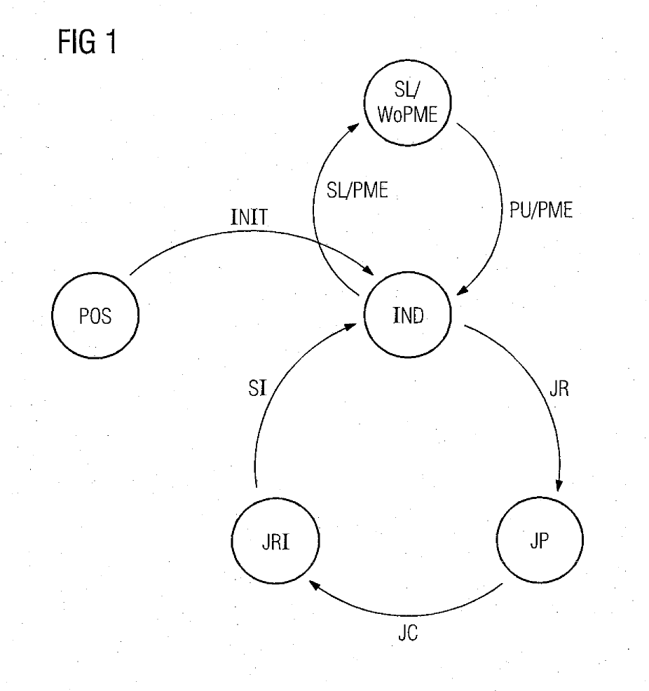

FIG. 1 schematically illustrates the representative states of a resource, a start state POS (Power-On-State) being taken as a basis. After an initialization phase INIT, the resource is initialized for the first time, state IND. As soon as the resource receives a job (JR=Job Received), the state JP (Job Pending) is established, the resource being busy and generally blocked. After the processing of the job (JC—Job Completed), the state JRI is established (JRI—Job Ready-Interrupt). This means that a driver of this resource receives the message that the job has been performed. Through the processing (SI—Servicing Interrupt) of the “finished message”, the resource undergoes transition to the state IND (Initialized) again. After a waiting time, the resource can receive from a power management (PM) the instruction SL/PME (Sleep/Power Management Event), whereby the resource is placed into the state SL/WoPME (Sleep-Waiting on Power Management Event). This means that the resource is in a “sleep state”, i.e., a power-saving state, while it waits for a further message of the power management. As soon as such a message PU/PME (Power Up/Power Management Event) arrives, the resource changes again to the state IND, such that it is ready for processing further jobs.

The aim of the configuration of a resource is generally to bring the resource into the state IND, which concerns both a possible driver (software) of the resource and a hardware unit that is linked to the resource or is part of the hardware unit. In the cases in which the state of the hardware unit cannot be influenced, the aim of the configuration is to place the driver (software) of the resource into a state corresponding to the state of the hardware unit of the resource.

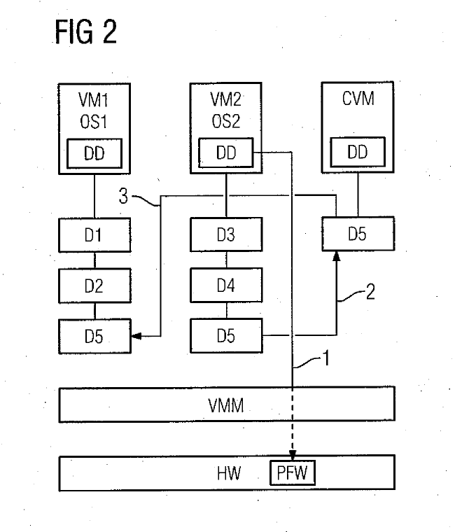

Resetting and changing (“Swapping”) of a resource D5 (Device 5) from one virtual runtime environment VM2 (Virtual Machine 2) with the guest operation system OS2 to another virtual runtime environment VM1 with the guest operation system OS1 is described below with reference to FIG. 2. Alongside the virtual runtime environments VM1, VM2 already mentioned, a third virtual runtime environment CVM (Configuration Virtual Machine) with a configuration device is additionally illustrated. Drivers DD (Device Driver) for the operation of resources are installed in each virtual runtime environment. In each case, the resources consist of corresponding real hardware units of the hardware platform HW or virtual hardware units of the management device VMM (not shown). The hardware units of the hardware platform HW are either directly addressed by the drivers DD of the virtual runtime environments VM1, VM2, CVM, or else mapped by a management device VMM (Virtual Machine Monitor) in a virtualized manner, such that the accesses of the drivers DD are intercepted and processed by the management device VMM. Some of the hardware units are linked to near-hardware driver software PFW (Platform Firmware), which can be, for example, a BIOS (Basic Input-Output System) of a motherboard of PC hardware, of a graphics card or the like. For each virtual runtime environment VM1, VM2, CVM, a respective list with the assigned resources D1, . . . , D5 is provided, where the lists are illustrated in the middle part of FIG. 2. The resource D5, mentioned later, by way of example, is firstly assigned to the virtual runtime environment VM2.

It should be assumed that a reset instruction is generated by the operation system OS2 and is sent to the hardware unit of the resource D5, which is illustrated by the arrow 1 in FIG. 2. The reason for the reset instruction may be, for example, that a user has activated the function “safely remove hardware” for the resource D5. The reset instruction is intercepted by the management device VMM, evaluated and forwarded to the configuration device of the virtual runtime environment CVM. The configuration device ascertains that the relevant resource is still assigned to the virtual runtime environment VM2 and therefore instructs the management device VMM to cancel this relationship.

The management device VMM, which is also often referred to as “Hypervisor”, then withdraws the resource D5 from the virtual runtime environment VM2. This means that, for example, in the case of a plug-and-play resource, i.e., a PCI-Express Network Card, for example, the fact that the resource D5 has been “unplugged” is signaled to the operation system OS2. The operation system OS2 thus ceases to use the resource D5. Subsequently, the resource D5 is deleted from the resource list of the virtual runtime environment VM2 and added to the resource list of the virtual runtime environment CVM, i.e., assigned to the virtual runtime environment CVM. This is represented by the arrow 2 in FIG. 2. The configuration device installed in the virtual runtime environment CVM then begins to place the resource D5 into an initial state. For a printer as resource D5 that would mean, for example, erasing the memory with the pending print jobs, emptying the paper path and moving a print head to a start state. These method steps required for a configuration of the resource D5 are preset in the configuration device as “configuration information” for all available resources D1, . . . D5. For the processing of these instructions, the operation system of the virtual runtime environment CVM is allocated operating cycles of a microprocessor and other resources by the management device VMM in the same way as is also the case for the other virtual runtime environments VM1, VM2. After the configuration of the resource D5 has been performed, the configuration device sends to the management device VMM a confirmation message stating that the configuration of the resource D5 has been concluded and that the start state has been reestablished. The resource D5 is then deleted from the resource list of the virtual runtime environment CVM by the management device VMM and can be used elsewhere. In the present example, it is assumed that the operation system OS1 has requested the use of the resource D5. Since the resource D5 is in a start state and can thus be used directly, the management device VMM assigns the resource D5 to the resource list of the virtual runtime environment VM1. This is symbolized by the arrow 3. Afterward, the resource D5 is thus available to the operation system OS1.

While the reassignment of a PCI-Express Network Card is a comparatively simple application, which can also still be controlled by conventional management devices themselves and without a separate configuration device, other resources are less simple to handle. By way of example, a “Programmable Interrupt Controller” (“PIC”) is a typical example of a hardware module of a PC architecture that cannot simply be “reset” without interrupting the operation of all the operation systems 051, 052. The configuration of such a PIC only with respect to a selected virtual runtime environment necessitates performing a specific method that cannot simply be mapped in a management device VMM and, moreover, if it were actually performed by a management device VMM, would block the management device VMM for a comparatively long time period. If, for example, such a PIC module is intended to be reconfigured after a “crash” of one of the operation systems OS1, OS2, the configuration device firstly has to ascertain whether the PIC hardware has a stored interrupt request in this regard or a “Pending Interrupt Servicing Bit” is set with regard to the affected operation system OS1, OS2. If this is the case, the configuration device has to erase this affected “ISR bit”, reset the corresponding “Interrupt is in Service” states of the PIC and reconfigure the remaining interrupt controller registers. It can be seen from these necessary method steps that the configuring device has to have detailed knowledge about the register structure of the hardware units used and of the assigned driver units. This knowledge may be bundled in the configuration device or retrieved by the configuration from a central data memory, such that the management device VMM is relieved of the burden both of the “knowledge” about the “how” of the configuration, and of performing the corresponding method steps.

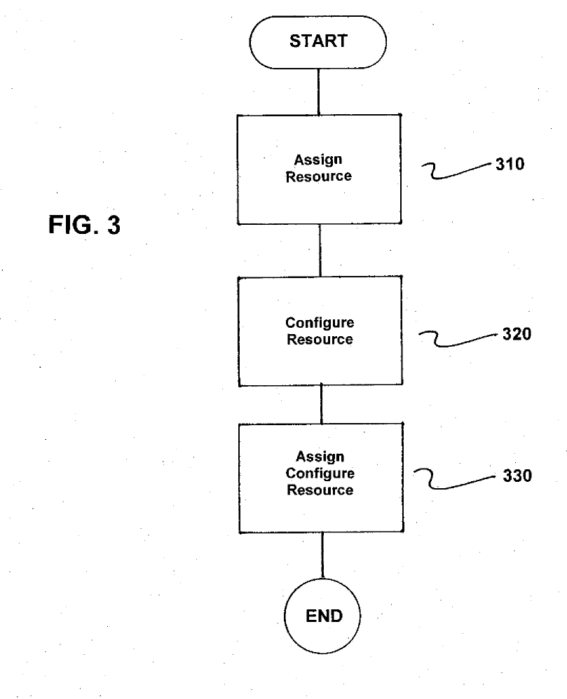

FIG. 3 is a flow chart of a method for configuring a resource for use by a first virtual runtime environment of a hardware platform via a management device for virtual runtime environments and a second virtual runtime environment with a configuration device. The method comprises assigning, by the management device, the resource to the second runtime environment, indicated in step 310. Next, the resource is configured by the configuration device, as indicated in step 320. The configured resource is then assigned to the first runtime environment, as indicated in step 330.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for configuring a resource for use by a first virtual runtime environment of a hardware platform via a management device for virtual runtime environments and a second virtual runtime environment with a configuration device, the method comprising:
assigning, by the management device, the resource to the second runtime environment;
configuring, by the configuration device, the resource; and
assigning the configured resource to the first runtime environment.

2. The method as claimed in claim 1, wherein during said configuring step, instead of a real hardware unit, a hardware unit simulating the resource to be configured is assigned to a driver entity of said resource before the configuration, the real hardware unit of the resource being reassigned to the driver entity after conclusion of the configuration.

3. The method as claimed in claim 1, wherein at least an additional third virtual runtime environment is provided alongside the first and second runtime environments.

4. The method as claimed in claim 3, wherein the resource is assigned to a third runtime environment before the assignment to the second runtime environment, the assignment being canceled by the management device before the step of assigning, by the management device, the resource to the second runtime environment.

5. The method as claimed in claim 1, wherein said configuring step comprises placing a hardware unit assigned to the resource into a predefined state.

6. The method as claimed in claim 5, wherein the predefined state comprises a start state of the hardware unit.

7. The method as claimed in claim 1, wherein said configuring step comprises placing a driver entity assigned to the resource into a defined state.

8. The method as claimed in claim 7, wherein the defined state corresponds to the state of the driver entity after a restart of the hardware platform.

9. The method as claimed in claim 8, wherein said configuring step comprises ascertaining a state of a hardware unit of the resource to be configured, the configuration further comprising placing the driver entity of the resource to be configured into a state corresponding to the state of the hardware unit.

10. The method as claimed in claim 7, wherein said configuring step comprises ascertaining a state of a hardware unit of the resource to be configured, the configuration further comprising placing the driver entity of the resource to be configured into a state corresponding to the state of the hardware unit.

11. The method as claimed in claim 1, wherein before said step of assigning, by the management device, the resource to the second runtime environment, the management device intercepts at least one reset instruction directed from an operation system in one of the virtual runtime environments, to which the resource to be configured is assigned, to one of the hardware platform and firmware of the hardware platform.

12. The method as claimed in patent claim 11, wherein the assignment of the resource to the second runtime environment and the configuration of the resource are initiated by the interception of the at least one reset instruction.

13. The method as claimed in claim 1, wherein a combined number of different resources are configured as the resource to be configured.

14. An arrangement for configuring a resource for use by a first virtual runtime environment of a hardware platform, the arrangement comprising:
at least one management device for virtual runtime environments installed on the hardware platform; and
at least one second virtual runtime environment including a configuration device arranged on the hardware platform;
wherein the management device is configured to assign the resource to be configured to the second virtual runtime environment;
wherein the configuration device is configured to configure the resource; and
wherein the management device is configured to assign the configured resource to the first virtual runtime environment after the configuration by the configuration device.
